(19) United States
(12) Patent Application Publication
(10) Pub. No.: US 2026/0339770 A1
(43) Pub. Date: Oct. 29, 2026

(54) SYSTEMS AND METHODS FOR PAYMENT TERMINALS CAPABLE OF DIAGNOSING, PREDICTING, AND RESOLVING OPERATIONAL ISSUES AUTONOMOUSLY USING ARTIFICIAL INTELLIGENCE (AI)

(71) Applicant: JPMORGAN CHASE BANK, N.A., New York, NY (US)

(72) Inventor: Mathew JACOB, Downingtown, PA (US)

(21) Appl. No.: 19/187,800

(22) Filed: Apr. 23, 2025

(51) Int. Cl. G06F 11/07; G06F 11/14

(52) U.S. Cl. CPC G06F 11/0793; G06F 11/0706; G06F 11/0766; G06F 11/1438; G06F 11/1441

(57) ABSTRACT

In some embodiments, the techniques described herein relate to a method including: a data collection module executed by one or more processors, the data collection module configured to gather real-time data from a payment terminal including one or more of a network interface, a hardware sensor, and a software log; an artificial intelligence (“AI”) diagnostic engine that analyzes the real-time data to detect anomalies in payment terminal operation; a predictive analytics module utilizing machine learning algorithms to forecast potential failures based on historical data and usage patterns; a self-healing system configured to autonomously applying corrective actions, including a restart of the payment terminal or a payment terminal interface, clearing memory of the payment terminal, and rebooting the payment terminal; and an AI-assisted troubleshooting assistant configured to apply a plurality of decision trees by passing the real-time data through one or more decision trees.

### BACKGROUND

### 1. Field of The Invention

Embodiments generally relate to systems and methods for electronic payment terminals.

### 2. Description of the Related Art

Payment terminals, widely used by merchants to accept card and contactless payments, are critical to business continuity. However, conventional payment terminals rely on rudimentary, rule-based diagnostics, requiring manual intervention for troubleshooting network issues, hardware failures (e.g., card reader malfunctions), and software errors. Current methods often result in extended downtimes, repetitive troubleshooting, and delayed issue resolution, significantly impacting merchants'operations and end-user satisfaction. Improved systems will use artificial intelligence (“AI”) to diagnose and troubleshoot payment terminals. Improved systems will proactively detect, predict, and resolve issues and be able to self-heal to correct a number of issues. The use of AI in improved systems, including machine learning models and predictive analytics will minimize or eliminate manual intervention, optimize terminal uptime, and enhance reliability.

### SUMMARY

Exemplary embodiments provide systems and methods for payment terminals capable of diagnosing, predicting, and resolving operational issues autonomously using Artificial Intelligence (AI). According to one embodiment, a method may include gathering, by a data collection module executed by one or more processors of a server, real-time data from a payment terminal including a network interface, a hardware sensor, and a software log; analyzing, by an artificial intelligence (“AI”) diagnostic engine executed by the server in operative communication with the data collection module, the real-time data to detect an anomaly in payment terminal operation; forecasting, by a predictive analytics module executed by the server using a plurality of decision trees, a potential failure of the network interface and the hardware sensor based on historical data and a usage pattern; executing, by a payment terminal and from a self-healing system executed by the server and in operative communication with the payment terminal, the one or more commands including a corrective action, the corrective action including a restart of the payment terminal or a payment terminal interface, clearing memory of the payment terminal, and rebooting the payment terminal; iterating, by an AI-assisted troubleshooting assistant executed by the server, through the plurality of decision trees by passing the real-time data through the plurality of decision trees and re-iterating through the plurality of decision trees until the anomaly is resolved; and analyzing, by a continuous learning module executed by the server, feedback from the payment terminal based on actions taken by the self-healing system and the AI-assisted troubleshooting assistant on the payment terminal.

In some embodiments, the AI diagnostic engine may identify one or more of a hardware anomaly, a card reader malfunction, a printer error, and a PIN pad failure. In some embodiments, the predictive analytics module may forecast network connectivity failures by analyzing connection stability and latency data. In some embodiments, the troubleshooting assistant may dynamically adjust the plurality of decision trees based on user inputs. In some embodiments, a dashboard interface may display a real-time terminal health, a predictive alert, and an actionable recommendation for issue resolution. In some embodiments, the continuous learning module may improve predictive analytics by analyzing anonymized performance data across multiple payment terminals in similar environments. In some embodiments, the AI diagnostic engine may generate error logs and provides detailed reports for remote technical support teams. In some embodiments, the plurality of decision trees may be divided into a number of categories and/or subcategories to allow for efficient navigation to a particular answer. In some embodiments, the AI diagnostic engine may change weights of one or more parameters of the plurality of decision trees. In some embodiments, the AI diagnostic engine may change a weight of a decision tree based on execution or bypass of one decision tree of the plurality of decision trees.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for payment terminals capable of diagnosing, predicting, and resolving operational issues autonomously using Artificial Intelligence (AI), in accordance with embodiments.

FIG. 2 is a method for payment terminals capable of diagnosing, predicting, and resolving operational issues autonomously using Artificial Intelligence (AI), in accordance with embodiments.

FIG. 3 is a block diagram of a computing device for implementing certain embodiments of the present disclosure.

### DETAILED DESCRIPTION

Embodiments generally relate to systems and methods for payment terminals capable of diagnosing, predicting, and resolving operational issues autonomously using Artificial Intelligence (AI).

Conventional payment terminals use rule-based diagnostics and even require manual intervention for troubleshooting network issues, hardware failures (e.g., card reader malfunctions), and software errors. These conventional methods are costly in time because of repetitive troubleshooting and delayed issue resolution. This significantly impacts operations and end-user satisfaction. Systems and methods disclosed herein may include artificial intelligence (“AI”) models that diagnose and troubleshoot payment terminals. Disclosed systems and methods may proactively detect, predict, and resolve issues and be able to self-heal to correct a number of issues. Machine learning models disclosed herein may use predictive analytics that will minimize or eliminate manual intervention, optimize terminal uptime, and enhance reliability. The invention relates to an AI-powered diagnostics and troubleshooting system integrated into payment terminals to address technical issues related to network connectivity, hardware components, and software performance.

Disclosed systems and methods may include advanced machine learning models, predictive algorithms, and self-healing capabilities to: diagnose issues by automatically detecting and identifying network, hardware, and software anomalies in real-time. Further, disclosed systems and methods may include AI predicting potential failures based on historical data, terminal usage patterns, and real-time performance metrics. Further, disclosed systems and methods may resolve problems autonomously by implementing self-healing mechanisms to fix minor issues (e.g., restarting network services, clearing memory) without human intervention. Further, disclosed systems and methods may include AI and machine learning models to analyze usage trends and historical data to predict failures. For example, a trend (e.g., of a time to print, a latency) indicating exceeding a threshold in a number of usage hours may be determined. Merchants receive advance alerts for maintenance or replacement, for example: “Card reader expected to fail in seven days due to increasing read errors.”

Further, disclosed systems and methods may assist or enact troubleshooting by providing or implementing step-by-step guidance for manual troubleshooting when issues require human input. Further, disclosed systems and methods may resolve improve continuously by leveraging continuous machine learning feedback loops to optimize diagnostics and prediction accuracy over time.

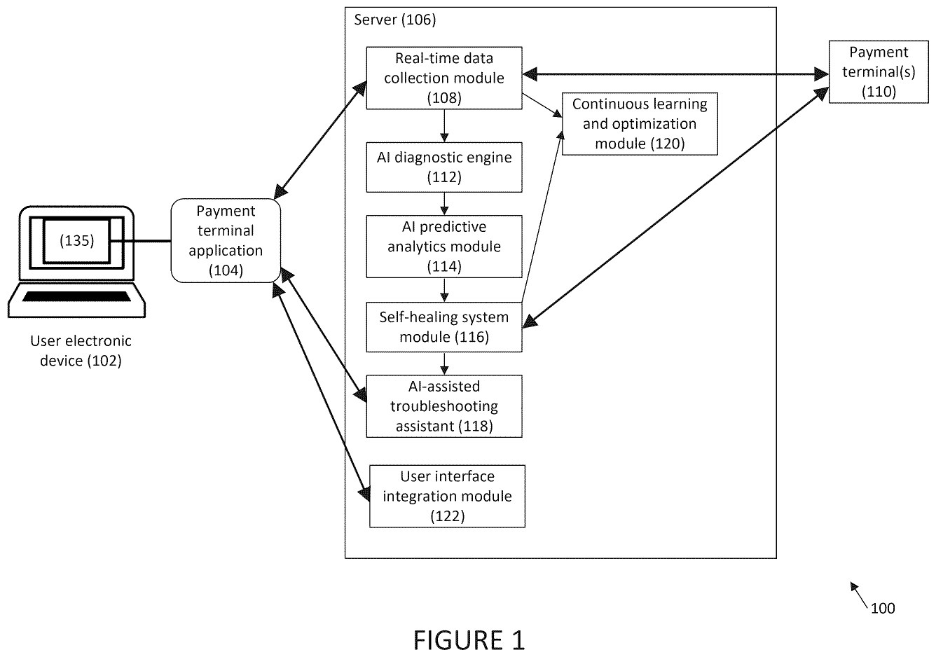

FIG. 1 is a block diagram of a system for payment terminals capable of diagnosing, predicting, and resolving operational issues autonomously using Artificial Intelligence (AI), in accordance with embodiments.

System 100 includes a user electronic device 102 executing a payment terminal application 104 available through user interface 135, a server 106 comprising a network or computer including a processor executing one or more software modules and a memory for storing data accessible by the one or more software modules and instructions to execute the one or more software modules. The one or more software modules may include a data real-time data collection module 108, AI diagnostic engine 112, AI predictive analysis module 114, self-healing system module 116, AI-assisted troubleshooting assistant 118, continuous learning and optimization module 120, and user interface integration module 122. One or more databases of server 106 may be accessed and/or include instructions for the one or more software modules.

The application 104 executed by one or more processors of user communication device 102 may access one or more databases of payment terminal records (not shown). User communication device 102 may be a computer configured to communicate over a wired or wireless interface with a computer network or Internet with server 106 and/or payment terminal(s) 110. The payment terminal records may be stored on an external database 110 such as in a temporary or permanent database. The external database 110 may be a cloud-based memory or a computer network memory. In some embodiments, the payment terminal records may be part of an internal database such as a memory or a group of memories as part of a computer network comprising server 106.

Although not shown, payment terminal application 104 may operate on a computer and include one or more of the one or more software modules included herein and communicate directly with payment terminal(s) 110.

Payment terminal 110 may be an electronic device configured to accept card (e.g., credit card, debit card) and other contactless payments (e.g., scanning QR codes, over near-field communication, through a mobile payment system).

Real-time data collection module 108 may collect data from hardware sensors, network interfaces, and software logs in the payment terminal. Hardware sensors may include one or more of power and battery, processor and memory (CPU, RAM, storage health—eMMC/SSD wear level), card readers, a display, a camera and/or bar code scanner, and security and tamper detection. Network interfaces may include Wi-Fi/Cellular/Bluetooth (e.g., signal strength, packet loss) and Payment Gateway connectivity (e.g., API response times, transaction success rate, downtime). Real-time data collection module 108 may gather system performance metrics, error logs, card reader input data, battery health, printer status, network stability, and/or software application performance. Performance metrics may include touch and/or user interface performance (e.g., touch latency, tap accuracy, screen refresh), user behavior and workload (e.g., average session duration including how long terminal remains active, peak transaction usage times, idle time between transaction to identify inefficiencies, abandonment rate including how many transactions are not completed). Software application performance may include application uptime and crashes (e.g., application crash rate, unhandled exceptions, app restart frequency), application responsiveness (e.g., local and response, screen transition speed, button press response), and/or touch and user interaction (e.g., touch latency, frozen screen events, user input errors).

AI diagnostic engine 112 may include a machine learning model or be operatively connected to a machine learning model, the machine learning model analyzing the collected data and identify anomalies. AI diagnostic engine 112 may recognize hardware degradation patterns, such as card reader wear-and-tear, thermal printer errors, or PIN pad malfunctions. Card reader wear and tear may be detected by monitoring the card reader metrics and determine if any metric breaches the set threshold limits. Card reader metrics may include swipe/insert success rate, read failure rate, reattempts per transaction, transaction time per card type, contactless tap detection rate and magnetic strip signal strength. Thermal printer issues may be detected by monitoring metrics, and determine if any metric breaches the set threshold limits, Thermal printer metrics may include print success rate, paper level, print head temperature, print speed, ink density and contrast, and/or jam detection events. PIN Pad malfunctions may be detected by monitoring metrics, and determine if any metric breaches the set threshold limits, PIN Pad metrics include keypress responsiveness, failed key press rate, pin entry success rate, key wear detection and tamper detection alerts.

AI diagnostic engine 112 may detect network issues, such as unstable Wi-Fi connections, DNS resolution failures, or latency problems. AI diagnostic engine 112 may apply software diagnostics to detect application crashes (e.g., applications executed on the payment terminal). Application crashes may be detected by an application of payment terminal(s) 110 not responding to a ping, sending a partial communication string when a full communication string is expected, not responding within a time threshold, or providing an application error from the payment terminal(s) 110 devices.

AI predictive analytics module 114 may predict future failures using historical and real-time data. AI diagnostic engine 112 may model system usage trends and environmental factors (e.g., high transaction volume during specific times, poor signal areas) to predict when critical hardware or network issues are likely to occur. AI diagnostic engine 112 may generate actionable insights (e.g., “Card reader may fail in 7 days due to repeated transaction errors”). Hardware failure may occur due to high transaction volume periods, long term use (3-5 years), dusty environments, frequent failed reads. Thermal printer failures may occur due to heavy transaction periods, low paper levels, extreme temperature shifts and after long idle periods. PIN pad failures may occur due to extended use (more than one million keystrokes per burton), physical tampering attempts, and/or harsh environments (humid/dust exposure). Battery failures may occur after extended charge cycles, heat exposure poor charging habits power fluctuations. Network issues may occur due to congestion, environmental interference or service provider disruptions.

Self-healing system module 116 may implement automated corrective actions, such as restarting network services to resolve connection issues. AI diagnostic engine 112 may clear an application cache or memory to optimize software performance. For a card reader, automatic recalibration (adjust EMC contact pressure) may be implemented. For a thermal printer, a print head cleaning (e.g., that may run a clearing cycle) may be implemented. For battery and power management, adaptive charging (adjust charge speed based on battery temperature) may be implemented. For a PIN Pad, a sensitivity may be adjusted for stuck or unresponsive keys and ghost press detection (filters out false keypress signals). For a Wi-Fi/ethernet, auto band switching network profile reset and dynamic channel selection may be implemented such that self-healing system module 116 detects congestion and switches to a better Wi-Fi. AI diagnostic engine 112 may perform a soft reboot of the terminal during off-peak hours to ensure smooth operation, off-peak hours determined by analyzing a transaction history (e.g., times of day when the payment terminal are not used or when the payment terminal has not been used within a threshold time period). AI diagnostic engine 112 may offers one-click fixes for more complex problems requiring user intervention, for example through payment terminal application 104.

As one example, fixing card reader issues (e.g., wear and tear, dirt, misalignment) may be accomplished to fix card reader failures due to dirt buildup or misalignment. In such a case, an auto diagnosis may occur such that AI diagnostic engine 112 detects multiple failed swipes or chip read errors. The auto diagnosis may be “Card reader needs cleaning. Tap ‘Fix Now’ to start. The card reader application may run an automatic self-test swipe with a diagnostic card (if available). AI diagnostic engine 112 may adjust the EMV reader contact pressure dynamically. AI diagnostic engine 112 may provide a step-by-step guide to cleaning the reader. AI diagnostic engine 112 may recommend and/or display a proposed user action such as following a generated on-screen guide to clean the reader. AI diagnostic engine 112 may generate a final verification that may include running a test swipe/tap and confirming the fix.

As another example, fixing a thermal printer issue (paper jam, fading prints) may be accomplished to fix a printer where the printer is misfeeding paper or producing faded prints. AI diagnostic engine 112 may auto-diagnose frequent printer errors and/or jam alerts. AI diagnostic engine 112 may generate a user prompt such as “Printer error detected. Tap ‘Fix Now’ to resolve.” AI diagnostic engine 112 may take system actions including one or more of checking, through one or more sensors, that a paper level and alignment is in expected parameters, running a self-cleaning print cycle, adjusting print contrast settings automatically for fading issues, recommending a user action if paper jam is detected, the screen provides an animation of how to remove stuck paper, and conducting a final verification such as running a test print and asking a user to confirm if the issue is resolved.

As another example, fixing a network connectivity issue (Wi-Fi, Cellular, Ethernet) may be accomplished to fix a terminal that frequently disconnects from the internet, for example, that causes failed transactions. A one-entry (e.g., one click) fix implementation may include auto-diagnosis by AI diagnostic engine 112 that detects high packet loss, slow API responses, and/or dropped network connections. AI diagnostic engine 112 may generate a user notice including, for example, “Network issue detected. Tap ‘Fix Now’ to optimize.” AI diagnostic engine 112 may take one or more system actions including forcing a reconnection to a best available network (e.g., a best available Wi-Fi network, a near-field communication network). AI diagnostic engine 112 may for example switch between 4G/5G carriers or resets APN settings for a cellular network. AI diagnostic engine 112 may run a cable connection test and refreshes the IP address for an ethernet connection. AI diagnostic engine 112 may, if required, prompts the user to check cable connections (Ethernet). AI diagnostic engine 112 may conduct a final verification that includes running a network speed test and asks the user to confirm if transactions work.

As another example, fixing a payment gateway API issues may be accomplished to fix a payment gateway API if it is slow and/or failing to process transactions. A one-entry (e.g., one click) fix implementation may include detecting and responding increased API response times and/or failed requests. AI diagnostic engine 112 may generate a user notice including, for example, “Payment processing issue detected. Tap ‘Fix Now’ to reconnect.” AI diagnostic engine 112 may take one or more system actions including re-authenticating API credentials if a session token expired. AI diagnostic engine 112 may take one or more system actions including switching to a backup payment gateway if the primary one is down. AI diagnostic engine 112 may take one or more system actions including retrying transactions automatically after re-establishing a connection. AI diagnostic engine 112 may, if required, prompts the user to restart the payment processor. AI diagnostic engine 112 may conduct a final verification that includes running a test transaction to confirm fix.

AI-assisted troubleshooting assistant 118 may provide an AI-guided troubleshooting process through dynamic decision trees. For example, if an issue is not resolvable through AI diagnostic engine 112, AI-assisted troubleshooting assistant 118 may pass one or more statuses of payment terminal(s) 110 from real-time data collection module 108 and historical fixes stored in a database associated with one or more issues and/or issue types, through a plurality of decision trees to determine a next troubleshooting action to take. This process may be iterative. AI-assisted troubleshooting assistant 118 may store attempts and/or resolutions for each decision tree and/or a category or sub-category of decision trees in a database for training for the machine learning model of AI diagnostic engine 112 and/or AI-assisted troubleshooting assistant 118 to determine what is or is not successful for each troubleshooting attempt for payment terminal(s) 110. AI-assisted troubleshooting assistant 118 may store each step towards resolution to reduce a number of decision trees used in a next troubleshooting attempt.

In some embodiments, steps to implement embodiments disclosed herein may, by AI diagnostic engine 112, detect an issue (e.g., card reader failure, network dropout, or printer jam) by parsing a card reader's logs. Based on the logs, AI diagnostic engine 112 may collect real-time diagnostics (sensor data, logs, error codes, performance history) related to the issue. AI diagnostic engine 112 may predict most likely causes using past data and suggests troubleshooting steps, for example, by detecting patterns related to the issue within the card reader's logs. The most likely cause may be converted to a category and/or subcategory of a plurality of decision trees. The plurality of decision trees may be divided into a number of categories and/or subcategories to allow for efficient navigation to a particular answer. For example, a category may be network connectivity issues, a subcategory may be an existing but slow connection (e.g., determined by upload speed, download speed, latency, bandwidth), and the plurality of decision trees may be related to resolving the network connectivity issues. In this example, the plurality of decision trees may include clearing a cache; determining an issue with an internet connection such as a router, an intermittent connection caused by interference (e.g., storm or metal), or distance from the router; outdated software; data caps; a threshold of devices on the network; one or more virtual private networks on the network; or a modem issue.

AI diagnostic engine 112 may, through modification of decision trees used by a machine learning model of the AI diagnostic engine 112, dynamically adjust a machine learning model's prediction method based on a past troubleshooting step, one or more diagnostics, one or more of user's responses to prompts (e.g., binary, on a scale), and/or system feedback (e.g., a past fix worked or did not work). AI diagnostic engine 112 may take self-healing actions automatically, minimizing or eliminating manual steps. The response, user prompt, troubleshooting steps, and/or self-healing actions may be efficient and directed to specific card reader issues.

For example, AI diagnostic engine 112 may detect multiple failed card swipes of a payment terminal. AI diagnostic engine 112 may determine a high failure rate for swipes/insertions of the payment terminal, may determine an increase of card reader error logs, a connectivity issue or a sustained connectivity issue over a time period (e.g., hour, day, week), a latency issue, and/or may receive a number of user complaints about “card not read” or equivalent. AI diagnostic engine 112 may identify an issue type such as by searching a database of similar issues and determining a relevant category or issue type. AI diagnostic engine 112 may verify detected issues by asking a user whether an issue relates to a magstripe, EMV chip, or contactless payment.

For example, AI diagnostic engine 112 may check one or more sensors and/or logs. For example, AI diagnostic engine 112 may determine whether card reader contact wear detected. If so, for example, AI diagnostic engine 112 may determine a prompt cleaning guide from a database related to the category, issue type, and/or sensor or log information. AI diagnostic engine 112 may determine multiple failed read attempts. If so, AI diagnostic engine 112 may adjust read sensitivity. AI diagnostic engine 112 may determine a weak near-field communication signal. If so, AI diagnostic engine 112 may check for interference.

For example, AI diagnostic engine 112 may generate a user guide including one or more troubleshoot steps generated based on the sensors and/or logs, the category and/or issue type, and the detected issue. For example, AI diagnostic engine 112 may generate text such as “try these steps: Insert the card slowly and hold it steady. Did it work?” Based on a user response and or final verifications, AI diagnostic engine 112 may determine if a problem is solved and/or beginning a self-cleaning mode and/or retrying correction steps disclosed herein. In some embodiments, AI diagnostic engine 112 may generate a support suggestion if the problem is still not resolved.

In some embodiments, AI-assisted troubleshooting assistant 118 may communicate with payment terminal application 104 to interact with a user through user interface 135. AI-assisted troubleshooting assistant 118 may accept yes/no answers from a user for each decision tree, along with status from real-time data collection module 108 to determine which decision tree to supply next. AI-assisted troubleshooting assistant 118 may, through payment terminal application 104, prompt users with context-aware questions and tailor recommendations based on issue type and historical fixes. In some embodiments, AI-assisted troubleshooting assistant 118 may integrate with support channels, such as live chat or remote technical support, by automatically sharing diagnostic logs and issue details.

Continuous learning and optimization module 120 may collect feedback from resolved issues and updates machine learning models to improve diagnostic accuracy. Continuous learning and optimization module 120 may learn from aggregated terminal performance data across multiple devices in the field to identify trends and common failure points. This is related to the AI that is deployed on the payment terminal (Edge AI). One terminal encounters a specific type of edge use case, learns a pattern to fix it, and then “teaches” the other terminals although other terminals may not have experienced similar issue before

User interface (UI) integration module 122 may, through communication with payment terminal application 104, provides a dashboard overview displaying system health, predicted issues, and real-time alerts. User interface (UI) integration module 122 may allow users to initiate manual diagnostics or apply suggested fixes with minimal navigation. User interface (UI) integration module 122 may support visual indicators (e.g., color-coded health gauges, alerts) to simplify issue identification for non-technical users.

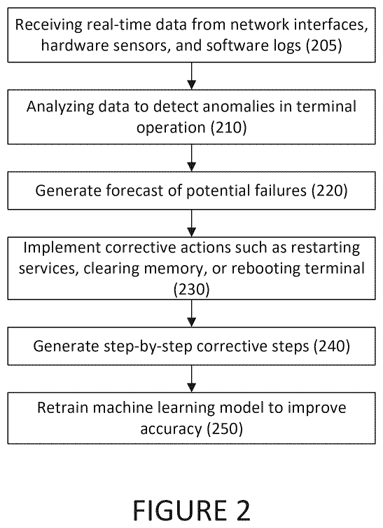

FIG. 2 is a method for payment terminals capable of diagnosing, predicting, and resolving operational issues autonomously using Artificial Intelligence (AI). The method may be stored as a list of instructions stored on a memory that when executed by one or more processors cause the one or more processors to perform the method.

Step 205 may include gathering, by a data collection module executed by one or more processors, real-time data from a payment terminal including one or more of a network interface, a hardware sensor, and a software log. A user interface executed on a computer and/or mobile communication device may comprise a dashboard interface to display the real-time data, a real-time health of the payment terminal, a predictive alert regarding the payment terminal, and an actionable recommendation for issue resolution for the payment terminal. The actionable recommendation may be a restart, clearing memory, restarting network services, running a diagnostic, or any other fix consistent with disclosed embodiments.

Step 210 may include analyzing, by an artificial intelligence (“AI”) diagnostic engine, the real-time data to detect one or more anomalies of the payment terminal. The AI diagnostic engine may identify one or more of a hardware anomaly, a card reader malfunction, a printer error, and a PIN pad failure. The AI diagnostic engine may generate one or more error logs and/or provides detailed reports for remote technical support teams. The anomalies may include one or more of a hardware failure (e.g., failure of a sensor or software component to respond when pinged or to provide an output within an expected time), a network failure (e.g., failure to maintain a latency, a download or an upload speed, a cache or an inability to download packets or software updates), a payment processing alert (e.g., missing information, payments over a threshold that may indicate malicious activity, transactions over a limit within a time period that may indicate malicious activity, a number of failed transaction attempts within a time period), a security alert (e.g., one or more new connections of the payment terminal, detected access attempts and/or failed access attempts), and a compliance alert (e.g., to update software, to connect to an internet connection within a time period, etc.). The hardware anomaly may be based on departure from a trend (e.g., a latency, print time, time to execute a transaction) over time (e.g., 1-5 business days, 1-8 business hours, 1-30 business days) or exceeding a threshold.

Step 220 may include generating, by a predictive analytics module utilizing machine learning, a forecast of one or more potential failures based on historical data and usage patterns. The predictive analytics module may forecast one or more network connectivity failures by analyzing connection stability and latency data. The predictive analytics may be based on

Step 230 may include implementing, by a self-healing system module, one or more corrective actions to the payment terminal, the one or more corrective action including one or more of a restart of the payment terminal or a payment terminal interface, clearing memory of the payment terminal, and rebooting the payment terminal.

Step 240 may include generating, by an AI-assisted troubleshooting assistant, a plurality of decision trees by passing the real-time data through one or more decision trees. The troubleshooting assistant may dynamically adjust the plurality of decision trees based on binary user input feedback and/or user input feedback on a scale (e.g., 1-10). The dynamic adjustment of the plurality of decision trees may change weights of one or more parameters of the plurality of decision trees. The weights may be changed to disfavor less likely decision trees and to favor more likely decision trees. For example, a printer issue involving failure to print may apply more weight to a decision tree to automatically restart a printer and may apply less weight to a decision tree to automatically clean the printer but may change the weights if a decision tree of an automatic load paper operation (e.g., a spool preparation phase) is executed and it is successful but an automatic test print operation does not execute properly (e.g., within a time limit, with ink, etc.). If that occurs, the weight of the decision tree may apply more weight to the decision tree based on the execution of the automatic load paper operation and determined continued issue to clean the printer and once the cleaning is executed, apply more weight to the printer restart decision tree. Similarly, weights of decision trees may be continually updated as one or more decision trees are executed, bypassed (e.g., if not applicable or not possible), or as other issue information is ingested. The troubleshooting assistance may execute the plurality of decision trees once updated.

Step 250 may include, analyzing, by a continuous learning module, feedback from the payment terminal based on actions taken by the self-healing system and the AI-assisted troubleshooting assistant on the payment terminal. The feedback may be whether an action was successful and/or whether normal operation resumed or not. Step 250 may include retraining a machine learning model of artificial intelligence (“AI”) diagnostic engine, predictive analytics module, self-healing system module, and/or AI-assisted troubleshooting assistant based on the feedback and/or historical data. The continuous learning module may improve predictive analytics by analyzing anonymized performance data across multiple payment terminals in similar environments

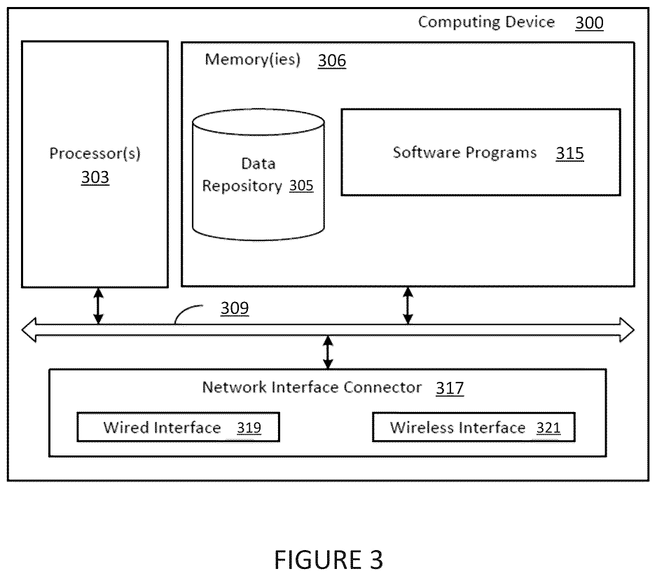

FIG. 3 is a block diagram of a computing device for implementing certain embodiments of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 703. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

1. A system comprising:
a data collection module executed by one or more processors of a server, the data collection module configured to gather real-time data from a payment terminal including a network interface, a hardware sensor, and a software log;
an artificial intelligence (“AI”) diagnostic engine executed by the server in operative communication with the data collection module that analyzes the real-time data to detect an anomaly in payment terminal operation;
a predictive analytics module executed by the server using a plurality of decision trees to forecast a potential failure of the network interface and the hardware sensor based on historical data and usage patterns;
a self-healing system executed by the server by communicating one or more commands to the payment terminal, the payment terminal configured to autonomously apply the one or more commands including a corrective action, the corrective action including a restart of the payment terminal or a payment terminal interface, clearing memory of the payment terminal, and rebooting the payment terminal;
an AI-assisted troubleshooting assistant executed by the server configured to apply the plurality of decision trees by passing the real-time data through the plurality of decision trees and re-iterating through the plurality of decision trees until the anomaly is resoled; and
a continuous learning module executed by the server configured to analyze feedback from the payment terminal based on actions taken by the self-healing system and the AI-assisted troubleshooting assistant on the payment terminal.

2. The system of claim 1, wherein the AI diagnostic engine identifies one or more of a hardware anomaly, a card reader malfunction, a printer error, and a PIN pad failure.

3. The system of claim 1, wherein the predictive analytics module forecasts network connectivity failures by analyzing connection stability and latency data.

4. The system of claim 1, wherein the troubleshooting assistant dynamically adjusts the plurality of decision trees based on user inputs.

5. The system of claim 1, further comprising a dashboard interface to display a real-time terminal health, a predictive alert, and an actionable recommendation for issue resolution.

6. The system of claim 1, wherein the continuous learning module improves predictive analytics by analyzing anonymized performance data across multiple payment terminals in similar environments.

7. The system of claim 1, wherein the AI diagnostic engine generates error logs and provides detailed reports for remote technical support teams.

8. The system of claim 1, wherein the plurality of decision trees may be divided into a number of categories and/or subcategories to allow for efficient navigation to a particular answer.

9. The system of claim 1, wherein the AI diagnostic engine may change weights of one or more parameters of the plurality of decision trees.

10. The system of claim 1, wherein the AI diagnostic engine may change a weight of a decision tree based on execution or bypass of one decision tree of the plurality of decision trees.

11. A method comprising:
gathering, by a data collection module executed by one or more processors of a server, real-time data from a payment terminal including a network interface, a hardware sensor, and a software log;
analyzing, by an artificial intelligence (“AI”) diagnostic engine executed by the server in operative communication with the data collection module, the real-time data to detect an anomaly in payment terminal operation;
forecasting, by a predictive analytics module executed by the server using a plurality of decision trees, a potential failure of the network interface and the hardware sensor based on historical data and a usage pattern;
executing, by a payment terminal and from a self-healing system executed by the server and in operative communication with the payment terminal, the one or more commands including a corrective action, the corrective action including a restart of the payment terminal or a payment terminal interface, clearing memory of the payment terminal, and rebooting the payment terminal;
iterating, by an AI-assisted troubleshooting assistant executed by the server, through the plurality of decision trees by passing the real-time data through the plurality of decision trees and re-iterating through the plurality of decision trees until the anomaly is resolved; and
analyzing, by a continuous learning module executed by the server, feedback from the payment terminal based on actions taken by the self-healing system and the AI-assisted troubleshooting assistant on the payment terminal.

12. The method of claim 11, wherein the AI diagnostic engine identifies one or more of a hardware anomaly, a card reader malfunction, a printer error, and a PIN pad failure.

13. The method of claim 11, wherein the predictive analytics module forecasts network connectivity failures by analyzing connection stability and latency data.

14. The method of claim 11, wherein the troubleshooting assistant dynamically adjusts the plurality of decision trees based on user inputs.

15. The method of claim 11, further comprising a dashboard interface to display a real-time terminal health, a predictive alert, and an actionable recommendation for issue resolution.

16. The method of claim 11, wherein the continuous learning module improves predictive analytics by analyzing anonymized performance data across multiple payment terminals in similar environments.

17. The method of claim 11, wherein the AI diagnostic engine generates error logs and provides detailed reports for remote technical support teams.

18. The method of claim 11, wherein the plurality of decision trees is divided into a number of categories and/or subcategories to allow for efficient navigation to a particular answer.

19. The method of claim 11, wherein the AI diagnostic engine changes weights of one or more parameters of the plurality of decision trees.

20. The method of claim 11, wherein the AI diagnostic engine changes a weight of a decision tree based on execution or bypass of one decision tree of the plurality of decision trees.
